(19) United States
(12) Patent Application Publication
(10) Pub. No.: US 2026/0221148 A1
(43) Pub. Date: Jul. 30, 2026

(54) AUDIO SIGNAL PROCESSING METHOD AND APPARATUS, STORAGE MEDIUM, AND ELECTRONIC DEVICE

(71) Applicant: Tencent Technology (Shenzhen) Company Limited, Shenzhen (CN)

(72) Inventor: Huanbin ZOU, Shenzhen (CN)

(21) Appl. No.: 19/636,729

(22) Filed: Apr. 1, 2026

Related U.S. Application Data
(63) Continuation of application No. PCT/CN2024/120318, filed on Sep. 23, 2024.

(30) Foreign Application Priority Data
Dec. 19, 2023 (CN) 202311758023.4

(51) Int. Cl. G10L 21/0232; G10L 25/18; G10L 25/30

(52) U.S. Cl. CPC G10L 21/0232; G10L 25/18; G10L 25/30

(57) ABSTRACT

An audio signal processing method is performed by an electronic device, and the method includes: acquiring first spectral features of a noisy audio signal, the noisy audio signal including a reference audio signal and a target audio signal to be extracted; inputting the first spectral features into a target neural network model to obtain reference phase estimation information matching the noisy audio signal, and the reference phase estimation information being configured for indicating phase differences between the target audio signal and the noisy audio signal at a plurality of frequency components; determining second spectral features according to the first spectral features and the reference phase estimation information; and determining the target audio signal according to the second spectral features.

### CROSS-REFERENCE TO RELATED APPLICATIONS

This application is a continuation application of PCT Patent Application No. PCT/CN2024/120318, entitled “AUDIO SIGNAL PROCESSING METHOD AND APPARATUS, STORAGE MEDIUM, AND ELECTRONIC DEVICE” filed on Sep. 23, 2024, which claims priority to Chinese Patent Application No. 2023117580234, entitled “AUDIO SIGNAL PROCESSING METHOD AND APPARATUS, STORAGE MEDIUM, AND ELECTRONIC DEVICE” filed on Dec. 19, 2023, all of which are incorporated herein by reference in their entirety.

### FIELD OF THE TECHNOLOGY

This application relates to the field of computers, and in particular, to an audio signal processing method and apparatus, a storage medium, and an electronic device.

### BACKGROUND OF THE DISCLOSURE

With continuous innovation of audio signal processing technologies, voice enhancement and noise reduction technologies have flourished. Currently, the voice enhancement technology is widely applied to scenes such as phone calls, video conferences, smart speakers, and voice recognition front-ends, bringing significant benefits to people's production and daily life.

In the related art, in a process of processing a noisy audio signal, to improve the accuracy of an analysis result, a complex neural network is adopted to perform modeling analysis on the noisy audio signal. Although this process may yield a relatively good analysis result, a huge calculation amount is generated, hindering widespread adoption of the voice analysis method. That is, the audio signal processing method provided in the related art suffers from low processing efficiency.

For the foregoing problem, no effective solution has been proposed yet.

### SUMMARY

Embodiments of this application provide an audio signal processing method and apparatus, a storage medium, and an electronic device.

According to an aspect of the embodiments of this application, an audio signal processing method is performed by an electronic device, and the method includes:
acquiring first spectral features of a noisy audio signal, the noisy audio signal including a reference audio signal and a target audio signal to be extracted;
inputting the first spectral features into a target neural network model to obtain reference phase estimation information matching the noisy audio signal, and the reference phase estimation information being configured for indicating phase differences between the target audio signal and the noisy audio signal at a plurality of frequency components;
determining second spectral features according to the first spectral features and the reference phase estimation information; and
determining the target audio signal according to the second spectral features.

According to yet another aspect of the embodiments of this application, a non-transitory computer-readable storage medium is further provided, having a computer program stored therein, the computer program being configured for performing the foregoing audio signal processing method.

According to yet another aspect of the embodiments of this application, an electronic device is further provided, including a memory and a processor, the memory having a computer program stored therein, and the processor being configured to perform the foregoing audio signal processing method or the foregoing method for training an audio signal processing model through the computer program.

Details of one or more embodiments of this application are provided in the accompanying drawings and descriptions below. Other features, objectives, and advantages of this application become apparent from the specification, the drawings, and the claims.

### BRIEF DESCRIPTION OF THE DRAWINGS

To more clearly illustrate the technical solutions in embodiments of this application or in conventional technology, the drawings required in the descriptions of the embodiments or the conventional technology will be briefly introduced below. It is clear that the drawings described below are only embodiments of this application, and a person skilled in the art may obtain other drawings according to the disclosed drawings without involving any creative effort.

FIG. 1 is a schematic diagram of an application environment of an exemplary audio signal processing method according to an embodiment of this application.

FIG. 2 is a flowchart of an exemplary audio signal processing method according to an embodiment of this application.

FIG. 3 is a schematic diagram of an exemplary audio signal processing method according to an embodiment of this application.

FIG. 4 is a schematic diagram of another exemplary audio signal processing method according to an embodiment of this application.

FIG. 5 is a schematic diagram of yet another exemplary audio signal processing method according to an embodiment of this application.

FIG. 6 is a flowchart of an exemplary method for training an audio signal processing model according to an embodiment of this application.

FIG. 7 is a schematic diagram of yet another exemplary audio signal processing method according to an embodiment of this application.

FIG. 8 is a schematic diagram of yet another exemplary audio signal processing method according to an embodiment of this application.

FIG. 9 is a schematic diagram of yet another exemplary audio signal processing method according to an embodiment of this application.

FIG. 10 is a schematic structural diagram of an audio signal processing apparatus according to an embodiment of this application.

FIG. 11 is a schematic structural diagram of an exemplary electronic device according to an embodiment of this application.

FIG. 12 is a schematic structural diagram of an exemplary apparatus for training an audio signal processing model according to an embodiment of this application.

FIG. 13 is a schematic structural diagram of another exemplary electronic device according to an embodiment of this application.

### DESCRIPTION OF EMBODIMENTS

Technical solutions in embodiments of this application will be clearly and completely described below with reference to the accompanying drawings in the embodiments of this application. It is clear that the described embodiments are merely some rather than all of the embodiments of this application. All other embodiments obtained by a person skilled in the art based on the embodiments of this application without making creative efforts fall within the protection scope of this application.

In the specification and claims of this application and the foregoing accompanying drawings, the terms “first”, “second”, and so on are intended to distinguish similar objects and are not necessarily used for describing a particular order or sequence. The data so used may be interchangeable where appropriate so that the embodiments of this application described herein, for example, can be implemented in an order except those illustrated or described herein. Moreover, the terms “include”, “have”, and any other variants mean to cover the non-exclusive inclusion, for example, a process, method, system, product, or device that includes a list of operations or units is not necessarily limited to those expressly listed operations or units, but may include other operations or units not expressly listed or inherent to such a process, method, product, or device.

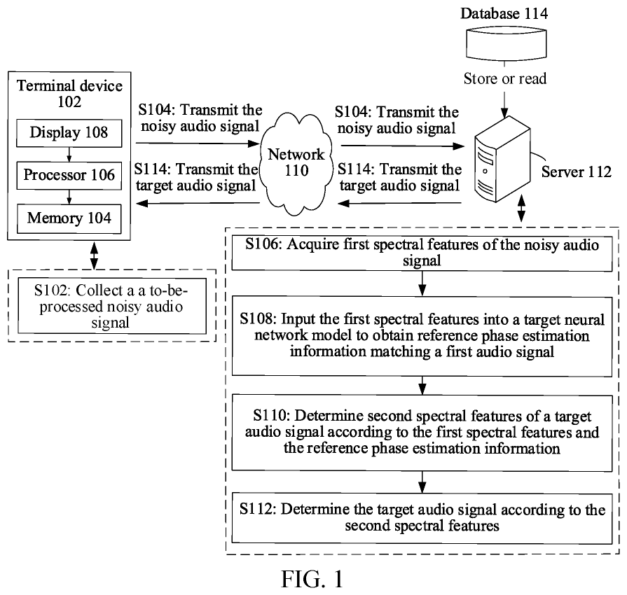

According to an aspect of the embodiments of this application, an audio signal processing method is provided. As an exemplary implementation, the foregoing audio signal processing method may be applied to, but is not limited to, an environment shown in FIG. 1. As shown in FIG. 1, the terminal device 102 includes a memory 104, configured to store various data generated in a running process of the terminal device 102; a processor 106, configured to process and compute the various data; and a display 108. The terminal device 102 may perform data interaction with a server 112 through a network 110. The server 112 is connected to a database 114, and the database 114 is configured to store various data.

In some embodiments, an application program that may be configured to collect an audio signal, for example, a recording application, may run in the terminal device 102. The recording application may collect an audio signal in an environment, transmit the collected audio signal to the server 112 for noise reduction, and acquire an audio signal obtained processed by the server 112.

Further, a corresponding specific application process of the foregoing method in the environment shown in FIG. 1 is shown in the following operations.

As shown in operation S102 and operation S104, the terminal device 102 collects a to-be-processed noisy audio signal. The noisy audio signal includes a reference audio signal and a target audio signal to be extracted. The reference audio signal and the target audio signal are each a noise signal or a clean voice signal in the noisy audio signal. The terminal device 102 transmits the noisy audio signal to the server 112 through a network 110.

Then, the server 112 performs operation S106 to operation S112: acquiring first spectral features of a noisy audio signal; inputting the first spectral features into a target neural network model to obtain reference phase estimation information matching the noisy audio signal, the target neural network model being obtained by pre-training according to a sample noisy audio signal and a sample target audio signal, and the reference phase estimation information being configured for indicating phase differences between a target audio signal and the noisy audio signal at a plurality of frequency components; and the sample target audio signal being a sample noise signal or a sample clean voice signal in the sample noisy audio signal; determining second spectral features of the target audio signal according to the first spectral features and the reference phase estimation information; and determining the target audio signal according to the second spectral features. Determining the second spectral features of the target audio signal according to the first spectral features and the reference phase estimation information includes: determining, according to first phase sine values and first phase cosine values that are indicated by the first spectral features, and reference phase sine values and reference phase cosine values that are indicated by the reference phase estimation information, second phase sine values and second phase cosine values that are configured for determining the second spectral features; and determining the second spectral features according to the second phase sine values and the second phase cosine values, and determining the target audio signal according to the second spectral features.

Next, the server 112 performs operation S114, that is, transmits the target audio signal to the terminal device 102 through the network 110.

In this embodiment of this application, the first spectral features of the noisy audio signal are first acquired. The noisy audio signal includes the reference audio signal and the target audio signal to be extracted. The reference audio signal and the target audio signal are each a noise signal or a clean voice signal in the noisy audio signal. The first spectral features are inputted into the target neural network model to obtain reference amplitude estimation information and reference phase estimation information that match the noisy audio signal. The target neural network model is obtained by pre-training according to the sample noisy audio signal and the sample target audio signal. The reference amplitude estimation information is configured for indicating amplitude differences between the target audio signal and the noisy audio signal at a plurality of frequency components, and the reference phase estimation information is configured for indicating phase differences between the target audio signal and the noisy audio signal at the plurality of frequency components. The second spectral features of the target audio signal are determined according to the first spectral features, the reference amplitude estimation information, and the reference phase estimation information. The target audio signal is determined according to the second spectral features, so that estimated values configured for representing phase differences and amplitude differences between audio signals are predicted through the target neural network model. Thus, a processed target audio signal is determined according to predicted reference amplitude estimation information, predicted reference phase estimation information, and spectral features of an original audio signal.

According to the foregoing implementation of this application, a technical solution in which modeling analysis may be performed on both amplitude information and phase information of the noisy audio signal is proposed, so that an audio signal interfered with by noise is obtained through comprehensive processing of the phase information, thereby improving the accuracy of audio signal processing. Meanwhile, phase information estimation is acquired using the target neural network, thereby avoiding using a complex neural network model, reducing the calculation amount, and improving the processing efficiency of audio signal processing.

In this embodiment, the foregoing terminal device may be a terminal device configured with a target client, and may include, but is not limited to, at least one of the following: a mobile phone (such as an Android mobile phone or an iOS mobile phone), a notebook computer, a tablet computer, a palmtop computer, a mobile Internet device (MID), a PAD, a desktop computer, a smart television, or the like. The target client may be a video client, an instant messaging client, a browser client, an education client, or the like. The foregoing network may include, but is not limited to, a wired network and a wireless network. The wired network includes a local area network, a metropolitan area network, and a wide area network. The wireless network includes Bluetooth, wireless fidelity (WIFI), and other networks implementing wireless communication. The foregoing server may be one server, a server cluster including a plurality of servers, or a cloud server. The foregoing is merely an example, and is not limited in this embodiment in any way.

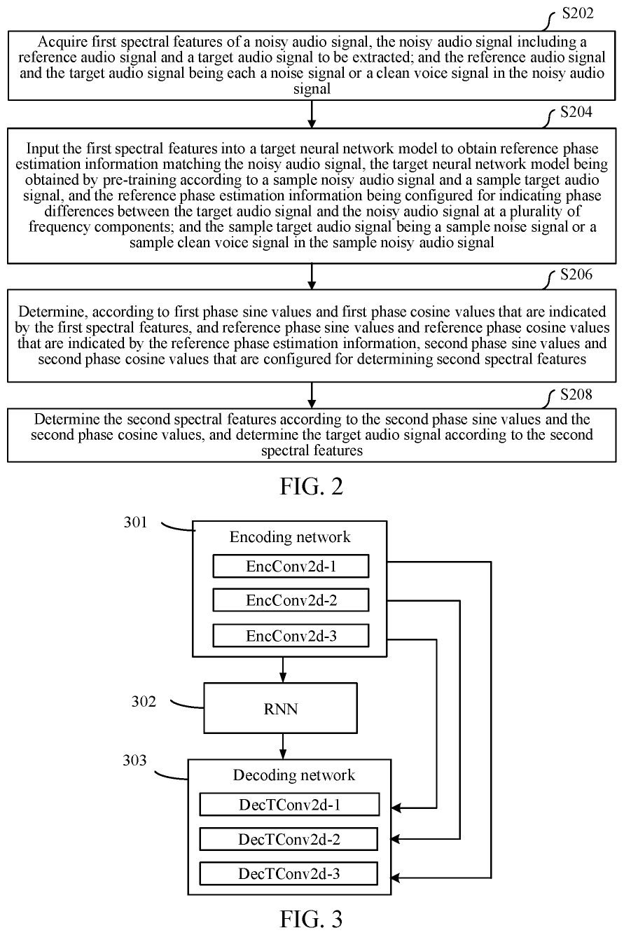

As an exemplary implementation, as shown in FIG. 2, the foregoing audio signal processing method includes the following operations.

S202: Acquire first spectral features of a noisy audio signal, the noisy audio signal including a reference audio signal and a target audio signal to be extracted; and the reference audio signal and the target audio signal being each a noise signal or a clean voice signal in the noisy audio signal.

S204: Input the first spectral features into a target neural network model to obtain reference phase estimation information matching the noisy audio signal, the target neural network model being obtained by pre-training according to a sample noisy audio signal and a sample target audio signal, and the reference phase estimation information being configured for indicating phase differences between the target audio signal and the noisy audio signal at a plurality of frequency components; and the sample target audio signal being a sample noise signal or a sample clean voice signal in the sample noisy audio signal.

When the reference audio signal is the noise signal in the noisy audio signal, the target audio signal is the clean voice signal in the noisy audio signal, and the sample target audio signal is the sample clean voice signal in the sample noisy audio signal. When the reference audio signal is the clean voice signal in the noisy audio signal, the target audio signal is the noise signal in the noisy audio signal, and the sample target audio signal is the sample noise signal in the sample noisy audio signal.

S206: Determine, according to first phase sine values and first phase cosine values that are indicated by the first spectral features, and reference phase sine values and reference phase cosine values that are indicated by the reference phase estimation information, second phase sine values and second phase cosine values that are configured for determining second spectral features.

S208: Determine the second spectral features according to the second phase sine values and the second phase cosine values, and determine the target audio signal according to the second spectral features.

In this embodiment, a technical solution in which modeling analysis may be performed on phase information of the noisy audio signal is proposed, so that an audio signal interfered with by noise is obtained through comprehensive processing of the phase information, thereby improving the accuracy of audio signal processing. Meanwhile, phase information estimation is acquired using the target neural network, thereby avoiding using the complex neural network model, reducing the calculation amount, and improving the processing efficiency of audio signal processing.

The foregoing audio signal processing method of this application may be applied to scenes including, but not limited to, an audio noise reduction scene or a scene in which a noise signal is extracted based on a noisy audio signal. In the audio noise reduction scene, the target audio signal is an audio signal on which noise reduction is performed, such as voice audio or instrumental audio. Correspondingly, in this scene, the reference audio signal is the noise signal in the noisy audio signal. In the scene in which the noise signal is extracted, the target audio signal is noise audio. Correspondingly, in this scene, the reference audio signal is the clean audio signal in the noisy audio signal, such as voice audio or instrumental audio. In the scene in which the noise signal is extracted, the extracted noise audio may be configured for further analyzing the noise signal or synthesizing noisy sample audio to train a noise reduction network model.

Specifically, in the scene in which the noise signal is extracted, the noisy audio signal is an audio signal collected in a target environment, and the target audio signal is ambient noise in the target environment. Further, target ambient noise in the target environment may be extracted through the foregoing implementation, and the acquired target ambient noise and different clean audio signals (such as a voice signal and an instrumental audio signal) are synthesized to obtain a noisy audio signal. Then, a noise reduction network is trained using the synthesized noisy audio signal to obtain a neural network model configured to process ambient noise of a specific environment.

In the audio noise reduction scene, the method may be specifically applied to a scene of noise reduction of an audio signal of video and audio recording, a voice call, a video call, a video conference, a camera device, a smart appliance, or the like. When the audio signal processing method is applied to the scene of noise reduction of the audio signal of video and audio recording, the noisy audio signal may be an audio signal collected from a video and audio recording environment, and carries a target audio signal that needs to be extracted, that is, the clean audio signal (such as a voice signal or an instrumental audio signal) and ambient noise. Further, noise reduction is performed through the foregoing implementation to acquire an audio signal not interfered with by noise. When the audio signal processing method is applied to the scene of noise reduction of the audio signal of the voice call, the method may be configured for performing noise reduction on an audio signal collected during the voice call, to acquire a noise-removed voice signal. When the audio signal processing method is applied to the scene of noise reduction of the audio signal of the camera device, the method may be configured for performing noise reduction on an audio signal collected by the camera device, to acquire a noise-removed voice signal. When the audio signal processing method is applied to the scene of noise reduction of the audio signal of the smart appliance, the method may be configured for performing noise reduction on an audio signal collected by the smart appliance, to obtain a noise-removed voice signal.

Further, when the audio signal processing method is configured for performing voice noise reduction, the noisy audio signal in operation S202 may be, but is not limited to, being configured for indicating an original voice signal collected by the terminal device. The voice signal includes a noise signal and a voice signal (target audio signal) to be extracted. For example, it is assumed that the audio signal processing method is applied to the scene of noise reduction of the audio signal of the voice call. If a user object A is currently on a call with a user object B through a terminal device a, the target audio signal may be an audio signal collected by the terminal device a from an environment where the user object A is located, and the audio signal includes a noise signal existing in the environment where the user object A is located and a voice signal produced by the user object A.

In some embodiments, a manner for acquiring the first spectral features of the noisy audio signal in operation S202 may be performing frequency-domain conversion on the noisy audio signal to obtain noisy frequency-domain features corresponding to the noisy audio signal. When the noisy audio signal is represented as xₙ, corresponding noisy frequency-domain features obtained by performing frequency-domain conversion on the noisy audio signal may be represented as Xₖ (complex). A real part and an imaginary part of Xₖ may each correspond to an array. A complex number formed by values corresponding to each of the real-number array and the imaginary-number array may be configured for representing a frequency domain signal at a particular frequency. Further, a combination of frequency domain signals at a plurality of different frequency domains may be represented as Xₖ, to obtain the first spectral features Xₖ.

After the first spectral features of the noisy audio signal are obtained, according to operation S204 and operation S206, corresponding reference phase estimation information may be obtained according to the first spectral features through a trained target neural network model, and the audio signal is extracted according to the reference phase estimation information.

In an exemplary implementation, determining the second spectral features according to the second phase sine values and the second phase cosine values and determining the second spectral features of the target audio signal according to the first spectral features, the reference amplitude estimation information, and the reference phase estimation information include: acquiring reference amplitude estimation information outputted by the target neural network model based on the first spectral feature, the reference amplitude estimation information being configured for indicating amplitude differences between the target audio signal and the noisy audio signal at the plurality of frequency components; determining, according to a first audio amplitude indicated by the first spectral features and the reference amplitude estimation information, a second audio amplitude matching the second spectral feature; and determining the second spectral features according to the second audio amplitude, the second phase sine values, and the second phase cosine values.

In the foregoing implementation, the second spectral features may be extracted through the reference amplitude estimation information and the reference phase estimation information that are outputted by the target neural network model.

The target neural network model may include, but is not limited to, a counterfactual recurrent network (CRN), a convolutional neural network (CNN), or a recurrent neural network (RNN). The network may be configured to extract corresponding reference amplitude estimation information and reference phase estimation information according to the first spectral features.

The reference amplitude estimation information may be configured for representing amplitude differences, in frequency domains, between the audio signal to be extracted and the noisy audio signal, and the reference phase estimation information may be configured for representing phase differences, in frequency domains, between the audio signal to be extracted and the noisy audio signal.

In an exemplary implementation, the amplitude difference may be an absolute value of an amplitude difference between the first spectral feature and the second spectral feature of the target audio signal. That is, the reference amplitude estimation information is a difference between an amplitude value of the first spectral feature and an amplitude value of the second spectral feature.

In another exemplary implementation, the amplitude difference may alternatively be an amplitude ratio of the first spectral feature to the second spectral feature of the target audio signal. That is, the reference amplitude estimation information is a ratio of the amplitude value of the first spectral feature to the amplitude value of the second spectral feature.

The amplitude value of the first spectral feature may be specifically represented as a first amplitude vector obtained by combining amplitude values of a plurality of frequency components, and the amplitude value of the second spectral feature may be specifically represented as a second amplitude vector obtained by combining amplitude values of a plurality of frequency components. Correspondingly, when the amplitude difference is the absolute value of the amplitude difference between the first spectral feature and the second spectral feature of the target audio signal, the reference amplitude estimation information may be represented as an amplitude vector corresponding to a vector difference between the first amplitude vector and the second amplitude vector. When the amplitude difference is the amplitude ratio of the first spectral feature to the second spectral feature of the target audio signal, the reference amplitude estimation information may be represented as an amplitude ratio vector formed by element ratios of corresponding elements in the first amplitude vector and the second amplitude vector.

In an exemplary implementation, the phase difference may be a sine value and a cosine value corresponding to a difference between signal phases represented by the first spectral feature and the second spectral feature of the target audio signal.

For example, when the phase difference is a signal phase difference represented by the first spectral feature and the second spectral feature, the difference may be represented through the following sine value and cosine value:

$$cos ∠ {\tilde{m}}_{k} = cos ( ∠ {\tilde{X}}_{k} - ∠ {\tilde{S}}_{k} )$$

$$sin ∠ {\tilde{m}}_{k} = sin ( ∠ {\tilde{X}}_{k} - ∠ {\tilde{S}}_{k} ) ,$$

where ∠\tilde{X}ₖ is a first spectral phase represented by the first spectral feature, and ∠\tilde{S}ₖ is a second spectral phase represented by the second spectral feature. cos ∠\tilde{m}ₖ is a cosine value configured for representing the phase difference, and sin ∠\tilde{m}ₖ is a sine value configured for representing the phase difference. ∠\tilde{X}ₖ and ∠\tilde{S}ₖ are two vectors of the same length, and each element in the vectors is configured for representing a phase corresponding to one frequency component. Correspondingly, cos ∠\tilde{m}ₖ is a cosine value vector, and sin ∠\tilde{m}ₖ is a sine value vector.

In another exemplary implementation, when the phase difference is the signal phase difference represented by the second spectral feature and the first spectral feature, the difference may be represented through the following sine value and cosine value:

$$cos ∠ {\tilde{m}}_{k} = cos ( ∠ {\tilde{S}}_{k} - ∠ {\tilde{X}}_{k} )$$

$$sin ∠ {\tilde{m}}_{k} = sin ( ∠ {\tilde{S}}_{k} - ∠ {\tilde{X}}_{k} ) .$$

After the reference amplitude estimation information and the reference phase estimation information are acquired through the foregoing operations, the second spectral features may be acquired according to the reference amplitude estimation information, the reference phase estimation information, and the first spectral feature, and then a corresponding target audio signal is acquired according to the second spectral features.

In some embodiments, in operation S206, the determining, according to first phase sine values and first phase cosine values that are indicated by the first spectral features, and reference phase sine values and reference phase cosine values that are indicated by the reference phase estimation information, second phase sine values and second phase cosine values that are configured for determining second spectral features includes: traversing, when the reference amplitude estimation information is configured for indicating phase differences between the target audio signal and the noisy audio signal at the N frequency components, the N frequency components indicated by the first spectral features, and acquiring a first phase sine value and a first phase cosine value that correspond to a currently traversed frequency component, N being an integer greater than 1; acquiring, from the reference phase estimation information, a reference phase sine value and a reference phase cosine value that correspond to the currently traversed frequency component; acquiring a first product of the first phase sine value and the reference phase cosine value, and a second product of the first phase cosine value and the reference phase sine value, and determining a sum of the first product and the second product as the second phase sine value; and acquiring a third product of the first phase cosine value and the reference phase cosine value, and a fourth product of the first phase sine value and the reference phase sine value, and determining the second phase cosine value according to a difference between the third product and the fourth product.

Specifically, when the reference amplitude estimation information is configured for indicating the phase differences between the target audio signal and the noisy audio signal at the N frequency components, the acquired reference phase sine value is sin ∠\tilde{m}ₖ, and the reference phase cosine value is cos ∠\tilde{m}ₖ, correspondingly, the second phase sine value and the second phase cosine value may be obtained in the following manner:

$$cos ∠ {\tilde{S}}_{k} = cos ( ∠ {\tilde{X}}_{k} + ∠ {\tilde{m}}_{k} ) = cos ∠ {\tilde{X}}_{k} \cdot cos ∠ {\tilde{m}}_{k} - sin ∠ {\tilde{X}}_{k} \cdot sin ∠ {\tilde{m}}_{k}$$

$$sin ∠ {\tilde{S}}_{k} = sin ( ∠ {\tilde{X}}_{k} + ∠ {\tilde{m}}_{k} ) = sin ∠ {\tilde{X}}_{k} \cdot cos ∠ {\tilde{m}}_{k} + cos ∠ {\tilde{X}}_{k} \cdot sin ∠ {\tilde{m}}_{k} ,$$

where cos ∠\tilde{S}ₖ is the second phase cosine value, and sin ∠\tilde{S}ₖ is the second phase sine value. cos ∠\tilde{S}ₖ, sin ∠\tilde{S}ₖ, cos ∠\tilde{X}ₖ, sin ∠\tilde{X}ₖ, cos ∠\tilde{m}ₖ, and sin ∠\tilde{m}ₖ in the foregoing formula are vector representations of the same dimension.

In this embodiment of this application, the first spectral features of the noisy audio signal are first acquired. The noisy audio signal includes the reference audio signal and the target audio signal to be extracted. The reference audio signal and the target audio signal are each a noise signal or a clean voice signal in the noisy audio signal. The first spectral features are inputted into the target neural network model to obtain reference amplitude estimation information and reference phase estimation information that match the noisy audio signal. The target neural network model is obtained by pre-training according to the sample noisy audio signal and the sample target audio signal. The reference amplitude estimation information is configured for indicating amplitude differences between the target audio signal and the noisy audio signal at a plurality of frequency components, and the reference phase estimation information is configured for indicating phase differences between the target audio signal and the noisy audio signal at the plurality of frequency components. The second spectral features of the target audio signal are determined according to the first spectral features, the reference amplitude estimation information, and the reference phase estimation information. The target audio signal is determined according to the second spectral features, so that estimated values configured for representing phase differences and amplitude differences between audio signals are predicted through the target neural network model. Thus, a processed target audio signal is determined according to predicted reference amplitude estimation information, predicted reference phase estimation information, and spectral features of an original audio signal.

According to the foregoing implementation of this application, a technical solution in which modeling analysis may be performed on both amplitude information and phase information of the noisy audio signal is proposed, so that an audio signal interfered with by noise is obtained through comprehensive processing of the amplitude information and the phase information, thereby improving the accuracy of audio signal processing. Meanwhile, the amplitude information and phase information estimation is acquired through the target neural network, thereby avoiding using the complex neural network model, avoiding increasing the calculation amount, and improving the processing efficiency of audio signal processing.

In some embodiments, the determining, according to a first audio amplitude indicated by the first spectral feature and the reference amplitude estimation information, a second audio amplitude configured for determining the second spectral features includes: acquiring, when the reference amplitude estimation information is configured for indicating reference amplitude ratios of the target audio signal to the noisy audio signal at N frequency components, first amplitude values at the N frequency components indicated by the first spectral features and N reference amplitude ratios indicated by the reference amplitude estimation information, N being an integer greater than 1; and determining product values of N first amplitude values and corresponding reference amplitude ratios as second amplitude values at the N frequency components matching the second spectral features.

Specifically, when the reference amplitude estimation information acquired through the target neural network model is configured for representing reference amplitude ratios of the target audio signal to the noisy audio signal at the N frequency components, the second audio amplitude may be acquired in the following manner:

It is assumed that the reference amplitude estimation information outputted by the target neural network model is |\tilde{m}ₖ|, and when the first audio amplitude of the noisy audio signal is |Xₖ|, the second audio amplitude corresponding to the second spectral feature of the target audio signal is:

$$\vert {\tilde{S}}_{k} \vert = \vert {X}_{k} \vert \cdot \vert {\tilde{m}}_{k} \vert .$$

|\tilde{S}ₖ|, |Xₖ|, and |\tilde{m}ₖ| in the foregoing formula are vectors of the same dimension.

In an exemplary implementation, the determining the second spectral features according to the second audio amplitude, the second phase sine values, and the second phase cosine values includes: determining a real-part representation in the second spectral features according to the second audio amplitude and the second phase cosine values; determining an imaginary-part representation in the second spectral features according to the second audio amplitude and the second phase sine values; and determining the second spectral features according to the real-part representation and the imaginary-part representation.

When cos ∠\tilde{S}ₖ, sin ∠\tilde{S}ₖ, and |\tilde{S}ₖ| are obtained, the second spectral feature may be expressed in the following manner:

$${\tilde{S}}_{k} = \vert {\tilde{S}}_{k} \vert \cdot cos ∠ {\tilde{S}}_{k} + 1 j \cdot \vert {\tilde{S}}_{k} \vert \cdot sin ∠ {\tilde{S}}_{k} ,$$

where |\tilde{S}ₖ|·cos ∠\tilde{S}ₖ is the real-part representation of the second spectral feature, and |\tilde{S}ₖ|·sin ∠\tilde{S}ₖ is the imaginary-part representation of the second spectral feature.

According to the foregoing implementation of this application, a technical solution in which modeling analysis may be performed on both amplitude information and phase information of the noisy audio signal is proposed, so that an audio signal interfered with by noise is obtained through comprehensive processing of the amplitude information and the phase information, thereby improving the accuracy of audio signal processing. Meanwhile, the amplitude information and phase information estimation is acquired through the target neural network, thereby avoiding using the complex neural network model, avoiding increasing the calculation amount, and improving the processing efficiency of audio signal processing.

In an exemplary implementation, the inputting the first spectral features into a target neural network model to obtain reference amplitude estimation information and reference phase estimation information that match the noisy audio signal includes: encoding the first spectral features in the target neural network model through an encoding network to obtain first encoding results; analyzing the first encoding results through an RNN constructed based on a gated recurrent unit (GRU), to obtain a first intermediate result carrying temporal information; and inputting the first encoding results and the first intermediate result into a decoding network in the target neural network model to obtain the reference amplitude estimation information and the reference phase estimation information that match the noisy audio signal, a sub-network in the decoding network being obtained based on adjustment of a sub-network in the encoding network.

In this embodiment of this application, the trained target neural network model may use, but is not limited to, an encoder-decoder interactive structure.

In some embodiments, the encoding the first spectral features through an encoding network includes: sequentially encoding the first spectral features through M encoding sub-networks that are connected in the encoding network, to obtain M first encoding results, each encoding sub-network including: a convolutional layer, a normalization layer, and an activation layer; when convolving a first spectral feature corresponding to each frame in the convolutional layer, a first spectral feature corresponding to an adjacent previous frame being referenced, and M being a natural number greater than or equal to 2.

In some embodiments, the analyzing the first encoding results through an RNN constructed based on a GRU, to obtain a first intermediate result carrying temporal information includes: inputting a first encoding result outputted by an M^{th} encoding sub-network into the RNN to obtain the first intermediate result carrying the temporal information.

In some embodiments, the inputting the first encoding results and the first intermediate result into a decoding network in the target neural network model to obtain the reference amplitude estimation information and the reference phase estimation information that match the noisy audio signal includes: inputting the first intermediate result and a first encoding result outputted by an i^{th} encoding sub-network into an (M−i+1)^{th} decoding sub-network, the decoding network including M decoding sub-networks that are connected, each decoding sub-network including: a transposed convolutional layer associated with the convolutional layer, a normalization layer, and an activation layer, i being an integer greater than or equal to 1 and less than or equal to M, and a skip connection being set between the i^{th} encoding sub-network and the (M−i+1)^{th} decoding sub-network; acquiring a first decoding result outputted by the M^{th} encoding sub-network; and determining the first decoding result as the reference amplitude estimation information and the reference phase estimation information that match the noisy audio signal.

A model structure of the target neural network model is described below with reference to FIG. 3. As shown in FIG. 3, the target neural network model includes an encoding network 301, an RNN 302, and a decoding network 303. The encoding network 301 includes a plurality of encoding sub-networks, the decoding network 303 includes a plurality of decoding sub-networks respectively in skip connection with the plurality of encoding sub-networks, and an input of each decoding sub-network is an output result of a corresponding encoding sub-network and an output result of the RNN 302.

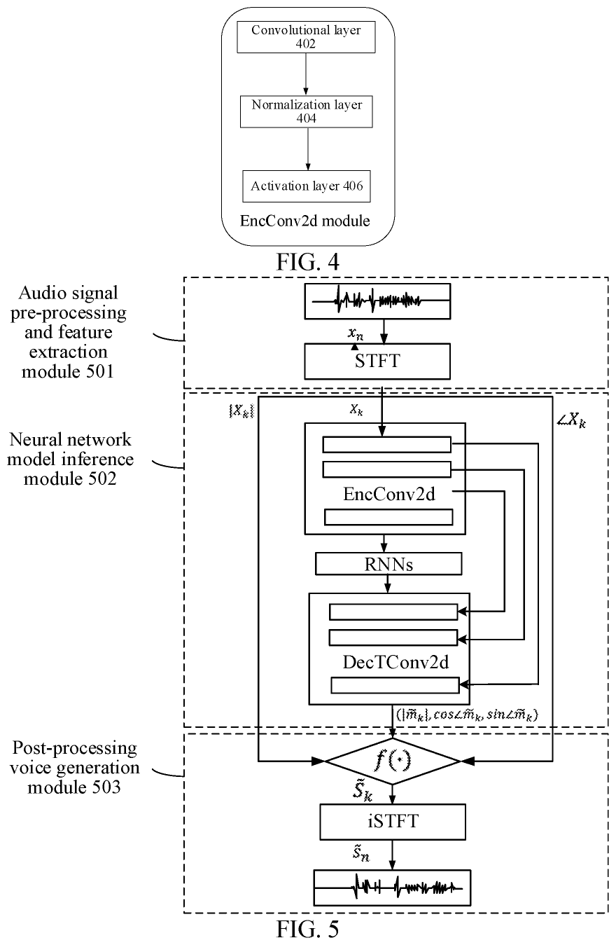

More specifically, each encoding sub-network in the encoding network 301 in FIG. 3 may be an EncConv2d module, and a network structure thereof may be shown in FIG. 4. The EncConv2d module includes a convolutional layer 402 (that is, two-dimensional convolution (Conv2d)), a normalization layer 404 (that is, normalization (BatchNorm)), and an activation layer 406 (that is, an activation function (PReLU)). A convolution kernel size of each layer of EncConv2d is (5, 2), indicating that a field of view of a frequency domain is 5, and a field of view of a time domain is 2. That is, analysis and processing of the feature of each frame of signal may refer to the previous frame of signal, which may be considered as a streaming convolution structure, ensuring the causality of the network. A stride of the convolution may be, but is not limited to, set to (2, 1), that is, a frequency-domain stride of the convolution is 2, and a time-domain stride is 1. In this way, a quantity of frequency-domain features of a signal can be halved layer by layer, and a dimension of time-domain features remains unchanged, which not only keeps time-domain continuity of information, but also can reduce the calculation amount.

Specifically, the RNN constructed based on the GRU may be, but is not limited to, being configured to indicate an extraction module. Specifically, the extraction module may be an RNN formed by stacking GRUs, and is configured to extract temporal information from an output result of the encoder.

In addition, each decoding sub-network in the decoding network 303 (that is, the decoder module) in FIG. 3 may be a sub-network corresponding to the encoding sub-network. Specifically, each decoding sub-network in the decoding network 303 may be configured to restore a quantity of frequency-domain features having the first frequency-domain features. The decoder module may be, but is not limited to, being formed by stacking DecTConv2d modules. The structure of DecTConv2d is highly similar to that of EncConv2d. The DecTConv2d includes: a transposed convolutional layer (that is, a transposed convolutional network (ConvTranspose2d)) corresponding to the convolutional layer (that is, the two-dimensional convolution (Conv2d)) in the EncConv2d, a normalization layer (that is, normalization (BatchNorm)), and an activation layer (that is, an activation function (PRELU)). A quantity of layers of DecTConv2d included in the decoder is the same as a quantity of layers of EncConv2d included in the encoder. A parameter of each layer of DecTConv2d layer is also the same as that of a corresponding layer of EncConv2. In addition, an output of each layer of the encoder may further be used as an influence parameter of a corresponding layer in the decoder module by skip connection, thereby realizing layer-by-layer restoration of a signal feature dimension.

Hereinafter, a process of processing the first frequency-domain features of the noisy audio signal through the target neural network model will be described in detail with reference to FIG. 3. The encoder (encoding network 301) receives a short-time Fourier transform (STFT) representation

$${X}_{k} = ( {X}_{k}^{r} , {X}_{k}^{i} )$$

of the noisy audio signal from a signal preprocessing module. Then, high-dimensional features are extracted layer by layer through EncConv2d, and a corresponding output is provided to DecTConv2d (decoding network 303) by skip connection. The RNN (RNN 302) receives output features of the last EncConv2d layer of the RNN, extracts and analyzes temporal information, and transmits the input to the decoder. The decoder receives outputs from the RNN and the encoder, and the dimension increases layer by layer through transposed convolution. A quantity of channels of the last DecTConv2d layer is 3, and three outputs are finally obtained, which are an amplitude spectrum mask estimation |\tilde{m}ₖ|, a phase spectrum mask estimation cosine value cos ∠\tilde{m}ₖ, and a sine value sin ∠\tilde{m}ₖ, respectively.

After the mask estimation of the voice signal is obtained, an STFT complex spectrum of an original noisy audio signal may be modulated to obtain the STFT of enhanced voice. The expressions are as follows.

A manner for determining an enhanced voice amplitude spectrum estimation is:

$$\vert {\tilde{S}}_{k} \vert = \vert {X}_{k} \vert \cdot \vert {\tilde{m}}_{k} \vert .$$

A manner for determining phase cosine estimation information is:

$$cos ∠ {\tilde{S}}_{k} = cos ( ∠ {\tilde{X}}_{k} + ∠ {\tilde{m}}_{k} ) = cos ∠ {\tilde{X}}_{k} \cdot cos ∠ {\tilde{m}}_{k} - sin ∠ {\tilde{X}}_{k} \cdot sin ∠ {\tilde{m}}_{k} .$$

A manner for determining phase sine estimation information is:

$$sin ∠ {\tilde{S}}_{k} = sin ( ∠ {\tilde{X}}_{k} + ∠ {\tilde{m}}_{k} ) = sin ∠ {\tilde{X}}_{k} \cdot cos ∠ {\tilde{m}}_{k} + cos ∠ {\tilde{X}}_{k} \cdot sin ∠ {\tilde{m}}_{k} .$$

A manner for determining enhanced voice STFT estimation information is:

$${\tilde{S}}_{k} = \vert {\tilde{S}}_{k} \vert \cdot cos ∠ {\tilde{S}}_{k} + 1 j \cdot \vert {\tilde{S}}_{k} \vert \cdot sin ∠ {\tilde{S}}_{k} .$$

After STFT estimation information of clean voice is obtained, inverse short-time Fourier transform (iSTFT) corresponding to STFT is finally performed to obtain a time-domain waveform signal \tilde{s}ₙ of the enhanced voice.

According to the foregoing implementation of this application, a voice enhancement solution in which modeling analysis is performed on both the amplitude spectrum and the phase spectrum of the noisy audio signal is provided, so that the model has a capability of learning clean human voice phase information while hardly increasing the network calculation complexity, thereby significantly improving the noise reduction effect.

In an exemplary implementation, the acquiring first spectral features of a noisy audio signal includes: acquiring the noisy audio signal; resampling the noisy audio signal according to a target sampling rate to obtain a first reference audio signal; performing time-domain framing and windowing on the first reference audio signal according to a framing parameter to obtain a plurality of first audio sub-signals; and performing discrete Fourier transform (DFT) on the plurality of first audio sub-signals to obtain the first spectral features corresponding to the plurality of first audio sub-signals.

The foregoing implementation provides a method for acquiring the first spectral features. First, a noisy audio signal xₙ is resampled, to resample audio data of all sampling rate types to 48 kHz. After the resampling operation is completed, time-domain framing and windowing are performed on a long audio signal. For example, the target audio signal may be segmented into a plurality of frames of short signals with a fixed length according to a fact that a single frame includes 1,024 sampling points (that is, a length of a single frame is 1,024) and a frame shift is 512 (that is, an overlapping length existing between every two adjacent frames is 512), but this is not limited thereto. Further, each frame of the signal in the target audio signal is modulated using a Hamming window to prevent spectrum leakage.

The windowing of the target audio signal is not limited to the Hamming window, and other manners, such as a rectangular window or a Hann window, may further be used. This is not limited in this embodiment.

After framing and windowing are performed on the noisy audio signal, the first spectral features may further be obtained using the STFT method. Specifically, the STFT is mathematical transform related to Fourier transform, and is configured for determining a frequency and a phase of a sine wave of a local region of a time-varying signal. Its core logic is to select a time-frequency localized window function. Assuming that the analysis window function g(t) is stationary (pseudo-stationary) within a short time interval, the window function is moved to make f(t) and g(t) stationary signals within different limited time widths, thereby calculating power spectra at different moments. Pseudo-stationary refers to a fluctuation being within a preset fluctuation range.

The amplitude spectrum is a curve of amplitude and frequency (angular frequency) of a signal. In the frequency-domain description of a signal, a frequency is used as an independent variable, and amplitudes of frequency components forming the signal are used as dependent variables. Such a frequency function is referred to as an amplitude spectrum, representing distribution of the amplitudes of the signal with the frequency. For the frequency-domain description of a random signal, a power spectrum is usually used, representing distribution of energy of the signal with the frequency.

Correspondingly, the determining the target audio signal according to the second spectral features includes: acquiring a plurality of second spectral features determined according to the first spectral features corresponding to the plurality of first audio sub-signals; performing iSTFT on the plurality of second spectral features to obtain a plurality of second audio sub-signals; and determining the target audio signal according to a concatenation result of the plurality of second audio sub-signals.

In the foregoing implementation, after the second spectral features of the target audio signal are obtained, iSTFT corresponding to STFT may be performed on the second spectral features to obtain a time-domain waveform signal \tilde{s}ₙ of the target audio signal.

The first spectral features correspond to the first audio sub-signals. Reference amplitude estimation information and reference phase estimation information that correspond to the first spectral features may be obtained through the target neural network model, and then the plurality of second spectral features are determined according to the first spectral features and the corresponding reference amplitude estimation information and reference phase estimation information. After iSTFT is performed on the second spectral features, the plurality of second audio sub-signals may be obtained. A quantity of second audio sub-signals is related to processing parameters in the process of performing time-domain framing and windowing on the noisy audio signal. The processing parameters include, but are not limited to, a single frame-length parameter and a frame shift parameter. The plurality of second audio sub-signals may be concatenated according to the foregoing parameters to obtain the target audio signal.

In an exemplary implementation, after the determining the second spectral features of the target audio signal according to the first spectral features, the reference amplitude estimation information, and the reference phase estimation information, the method further includes: determining reference spectral features of the reference audio signal according to the first spectral features and the second spectral features; and performing iSTFT on the reference spectral features to obtain the reference audio signal.

In this implementation, after the target audio signal is extracted from the noisy audio signal through the foregoing implementation, the reference spectral features of the reference audio signal may be further determined according to the first spectral features and the second spectral features, thereby extracting the reference spectral features. Then, iSTFT is performed according to the reference spectral features to obtain the reference audio signal.

When the target audio signal is an audio signal obtained after noise reduction, correspondingly, the reference audio signal may be a noise signal. When the target audio signal is an extracted noise signal, correspondingly, the reference audio signal may be an audio signal obtained after noise reduction.

A complete audio processing process of this application will be described below with reference to FIG. 5. In this implementation, the noisy audio signal is a noisy audio signal, the target audio signal is a clean voice signal to be extracted, and the reference audio signal is a noise signal.

As shown in FIG. 5, a specific implementation system framework is mainly divided into three modules, which are an audio signal pre-processing and feature extraction module 501, a neural network model inference module 502, and a post-processing voice generation module 503, respectively.

The pre-processing and feature extraction module 501 may first resample a noisy audio signal xₙ, to resample audio data of all sampling rate types to 48 kHz. After the resampling operation is completed, time-domain framing and windowing are performed on a long audio signal. An original audio signal is segmented into a plurality of frames of short signals with a fixed length according to a single frame length of 1,024 and a frame shift of 512 (overlapping of 512), and each frame of the signal is modulated using a Hamming window to prevent spectrum leakage. After the framing and windowing operations end, a DFT operation is performed on the modulated signal to extract frequency-domain features, to obtain frequency-domain representations Xₖ (complex) of the noisy audio signal xₙ. A combination of framing and windowing and the DFT operation of the audio signal may alternatively be referred to as STFT.

In the neural network model inference module 502, an encoder-decoder framework is used in this implementation. The encoder part mainly includes an EncConv2d structure with two-dimensional convolution (Conv2d) as a kernel. A convolution kernel size of each layer of EncConv2d is (5, 2), representing that a field of view of a frequency domain is 5, and a field of view of a time domain is 2. Analysis and processing of the feature of each frame of signal may refer to the previous frame of signal. A convolution stride is (2, 1), which can halve a quantity of frequency-domain features of a signal layer by layer, and remain a quantity of time-domain frames unchanged, thereby achieving dimension reduction and reducing the calculation amount. The decoder part mainly includes DecTConv2d with transposed two-dimensional convolution (ConvTranspose2d) as a kernel. Parameters of each layer of DecTConv2d are the same as those of the corresponding EncConv2d, realizing restoration of a signal dimension. Between the encoder and the decoder, an RNN module formed by stacking GRUs is used in the present disclosure. The functions of the RNN are mainly to extract and analyze inter-frame temporal information of an audio signal. Therefore, a workflow of a deep learning network module is as follows. The encoder receives an STFT representation

$${X}_{k} = ( {X}_{k}^{r} , {X}_{k}^{i} )$$

of the noisy audio signal from a signal preprocessing module. Then, high-dimensional features are extracted layer by layer through EncConv2d, and a corresponding output is provided to DecTConv2d by skip connection. The RNN receives output features of the last EncConv2d layer of the RNN, extracts and analyzes temporal information, and transmits the input to the decoder. The decoder receives outputs from the RNN and the encoder, and the dimension increases layer by layer through transposed convolution. A quantity of channels of the last DecTConv2d layer is 3, and three outputs are finally obtained, which are an amplitude spectrum mask estimation |\tilde{m}ₖ|, a phase spectrum mask estimation cosine value cos ∠\tilde{m}ₖ, and a sine value sin ∠\tilde{m}ₖ, respectively.

After the mask estimation of the voice signal is obtained, in the post-processing voice generation module 503, an STFT complex spectrum of an original noisy audio signal may be modulated to obtain the STFT of enhanced voice. The expressions are as follows.

A manner for determining an enhanced voice amplitude spectrum estimation is:

$$\vert {\tilde{S}}_{k} \vert = \vert {X}_{k} \vert \cdot \vert {\tilde{m}}_{k} \vert .$$

A manner for determining phase cosine estimation information is:

$$cos ∠ {\tilde{S}}_{k} = cos ( ∠ {\tilde{X}}_{k} + ∠ {\tilde{m}}_{k} ) = cos ∠ {\tilde{X}}_{k} \cdot cos ∠ {\tilde{m}}_{k} - sin ∠ {\tilde{X}}_{k} \cdot sin ∠ {\tilde{m}}_{k} .$$

A manner for determining phase sine estimation information is:

$$sin ∠ {\tilde{S}}_{k} = sin ( ∠ {\tilde{X}}_{k} + ∠ {\tilde{m}}_{k} ) = sin ∠ {\tilde{X}}_{k} \cdot cos ∠ {\tilde{m}}_{k} + cos ∠ {\tilde{X}}_{k} \cdot sin ∠ {\tilde{m}}_{k} .$$

A manner for determining enhanced voice STFT estimation information is:

$${\tilde{S}}_{k} = \vert {\tilde{S}}_{k} \vert \cdot cos ∠ {\tilde{S}}_{k} + 1 j \cdot \vert {\tilde{S}}_{k} \vert \cdot sin ∠ {\tilde{S}}_{k} .$$

After STFT estimation information of clean voice is obtained, inverse short-time Fourier transform (iSTFT) corresponding to STFT is finally performed to obtain a time-domain waveform signal \tilde{s}ₙ of the enhanced voice.

According to the foregoing implementation of this application, a voice enhancement solution in which modeling analysis is performed on both the amplitude spectrum and the phase spectrum of the noisy audio signal is provided, so that the model has a capability of learning clean human voice phase information while hardly increasing the network calculation complexity, thereby significantly improving the noise reduction effect.

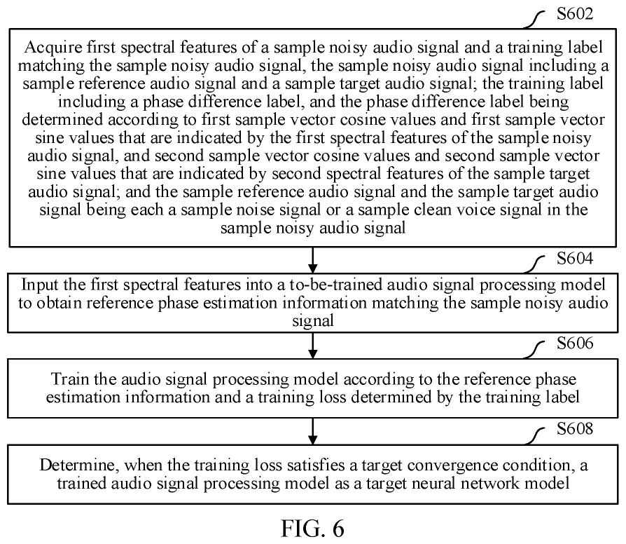

In an exemplary implementation, this application further provides a method for training an audio signal processing model. As shown in FIG. 6, the method includes the following operations.

S602: Acquire first spectral features of a sample noisy audio signal and a training label matching the sample noisy audio signal, the sample noisy audio signal including a sample reference audio signal and a sample target audio signal; the training label including a phase difference label, and the phase difference label being determined according to first sample vector cosine values and first sample vector sine values that are indicated by the first spectral features of the sample noisy audio signal, and second sample vector cosine values and second sample vector sine values that are indicated by second spectral features of the sample target audio signal; and the sample reference audio signal and the sample target audio signal being each a sample noise signal or a sample clean voice signal in the sample noisy audio signal.

When the reference audio signal is the noise signal in the noisy audio signal, the target audio signal is the clean voice signal in the noisy audio signal, the sample reference audio signal is the sample noise signal in the sample noisy audio signal, and the sample target audio signal is the sample clean voice signal in the sample noisy audio signal. When the reference audio signal is the clean voice signal in the noisy audio signal, the target audio signal is the noise signal in the noisy audio signal, the sample reference audio signal is the sample clean voice signal in the sample noisy audio signal, and the sample target audio signal is the sample noise signal in the sample noisy audio signal.

S604: Input the first spectral features into a to-be-trained audio signal processing model to obtain reference phase estimation information matching the sample noisy audio signal.

S606: Train the audio signal processing model according to the reference phase estimation information and a training loss determined by the training label.

S608: Determine, when the training loss satisfies a target convergence condition, a trained audio signal processing model as a target neural network model.

In an exemplary implementation, the training the audio signal processing model according to the reference phase estimation information and a training loss determined by the training label includes: inputting the first spectral features into the to-be-trained audio signal processing model to obtain reference amplitude estimation information matching the sample noisy audio signal, an amplitude difference label being determined according to amplitude differences between the sample noisy audio signal and the sample target audio signal at a plurality of frequency components; and training the audio signal processing model according to the reference amplitude estimation information, the reference phase estimation information, and the training loss determined by the training label.

In the foregoing implementation of this application, the corresponding sample noisy audio signal and sample target audio signal may be determined according to the actual use of the target neural network model.

When the target neural network model is configured for performing a voice noise reduction operation, the sample noisy audio signal may be a noisy sample voice signal, the sample target audio signal may be the sample clean voice signal, and the sample reference voice signal may be the noise signal.

When the target neural network model is configured for performing a noise extraction operation, the sample noisy audio signal may be a noisy sample voice signal, the sample target audio signal may be the noise signal, and the sample reference voice signal may be the sample clean voice signal.

An example in which the target neural network model is configured for performing a voice noise reduction operation is used for description. In the foregoing training process, a clean voice data set (sample target audio signal) and a noise data set (reference noise signal) may be mixed to generate the noisy audio signal (sample noisy audio signal), signal-to-noise ratio (SNR) conditions of the noisy audio signal in different noise environments are simulated by controlling a noise mixing ratio, and the model is trained using a supervised learning method. It is assumed that the clean voice signal is sₙ, the noise signal is dₙ, and corresponding STFTs are Sₖ and Dₖ, respectively. Therefore, the noisy audio signal xₙ is:

$${x}_{n} = {s}_{n} + {d}_{n} .$$

Correspondingly, a representation manner after the STFT is performed is as follows:

$${X}_{k} = {S}_{k} + {D}_{k} ,$$

where Xₖ is a frequency-domain representation of xₙ, Sₖ is a frequency-domain representation of sₙ, and Dₖ is a frequency-domain representation of dₙ.

In an exemplary implementation, the acquiring first spectral features of a sample noisy audio signal and a training label matching the sample noisy audio signal includes: acquiring the sample target audio signal and the sample reference audio signal, and obtaining the sample noisy audio signal by mixing the sample target audio signal and the sample reference audio signal; separately acquiring the first spectral features of the sample noisy audio signal and the second spectral features of the sample target audio signal; and determining the amplitude difference label and the phase difference label according to the first spectral features and the second spectral features.

In an exemplary implementation, the determining the amplitude difference label and the phase difference label according to the first spectral features and the second spectral features includes: acquiring first sample amplitude values of the sample noisy audio signal at N frequency components according to the first spectral features, and acquiring second sample amplitude values of the sample target audio signal at the N frequency components according to the second spectral features, N being an integer greater than 1; determining the amplitude difference label according to ratios of N second sample amplitude values to corresponding first sample amplitude values; acquiring first sample vector cosine values and first sample vector sine values of the sample noisy audio signal at the N frequency components according to the first spectral features, and acquiring second sample vector cosine values and second sample vector sine values of the sample target audio signal at the N frequency components according to the second spectral features; and determining the phase difference label according to N first sample vector cosine values, N sample vector sine values, corresponding second sample vector cosine values, and corresponding second sample vector sine values.

In the foregoing manner, an ideal amplitude mask |mₖ| configured for determining the amplitude difference label may be determined, which may be specifically represented as:

$$\vert {m}_{k} \vert = \frac{\vert {s}_{k} \vert}{\vert {x}_{k} \vert} .$$

In the foregoing manner, an ideal phase cosine mask cos ∠\tilde{m}ₖ configured for determining the phase difference label may be determined, which may be specifically represented as:

$$cos ∠ {\tilde{m}}_{k} = cos ( ∠ {\tilde{S}}_{k} - ∠ {\tilde{X}}_{k} ) .$$

In the foregoing manner, an ideal phase sine mask sin ∠\tilde{m}ₖ configured for determining the phase difference label may be determined, which may be specifically represented as:

$$sin ∠ {\tilde{m}}_{k} = sin ( ∠ {\tilde{S}}_{k} - ∠ {\tilde{X}}_{k} ) .$$

After the phase difference label and the amplitude difference label are determined through the foregoing implementation of this application, the audio signal processing model shown in FIG. 3 may be trained according to the foregoing phase difference label and amplitude difference label.

In an exemplary implementation, the inputting the first spectral features into a to-be-trained audio signal processing model to obtain reference amplitude estimation information and reference phase estimation information that match the sample noisy audio signal includes: encoding the first spectral features in the audio signal processing model through an encoding network to obtain first encoding results; analyzing the first encoding results through an RNN constructed based on a GRU, to obtain a first intermediate result carrying temporal information; and inputting the first encoding results and the first intermediate result into a decoding network in the audio signal processing model to obtain the reference amplitude estimation information and the reference phase estimation information that match the sample noisy audio signal, a sub-network in the decoding network being obtained based on adjustment of a sub-network in the encoding network.

In the training process, the reference amplitude estimation information and the reference phase estimation information that match the sample noisy audio signal are obtained through the audio signal processing model shown in FIG. 3 based on the first spectral features, and then the training loss is determined with reference to the training label matching the sample noisy audio signal.

Specifically, the foregoing training loss may be obtained in the following manner:

$$L = {L}_{t} ( {s}_{n} , {\tilde{s}}_{n} ) + λ \cdot {L}_{f} ( {\tilde{S}}_{k} , {S}_{k} ) ,$$

where Lₜ(sₙ,\tilde{s}ₙ) is configured for representing a loss of (sₙ,\tilde{s}ₙ) in a time domain, which may adopt, but is not limited to, any one of a mean square error loss function (MSE), a mean absolute error loss function (MAE), a scale invariant signal-to-noise ratio (SI-SNR), and the like. L_{f}(\tilde{S}ₖ,Sₖ) is a frequency-domain loss of \tilde{S}ₖ,Sₖ, and any one of an MSE and an MAE may be adopted. λ is a loss weight allocation coefficient, and is determined according to an experimental training situation.

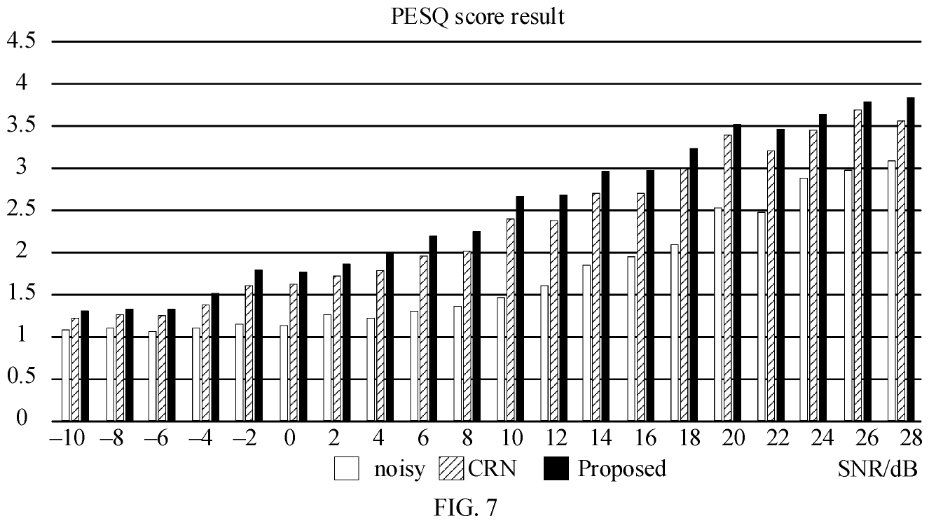

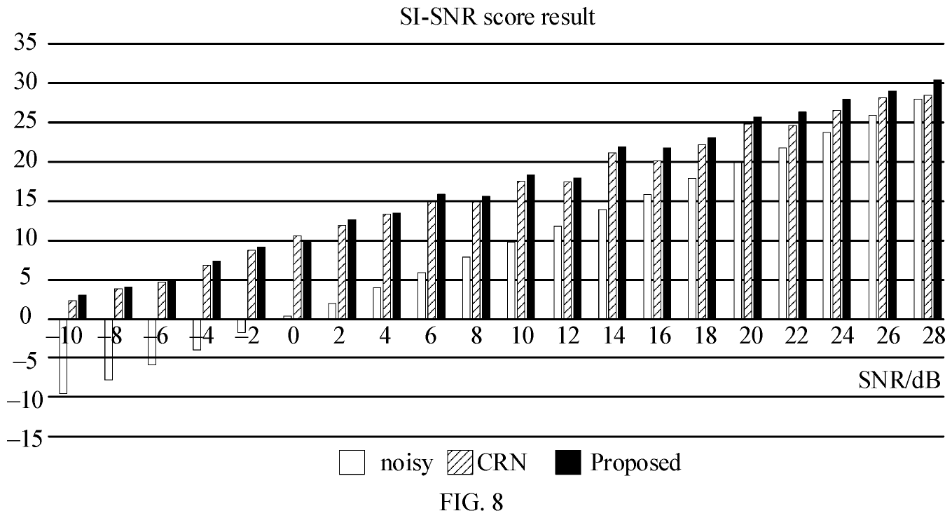

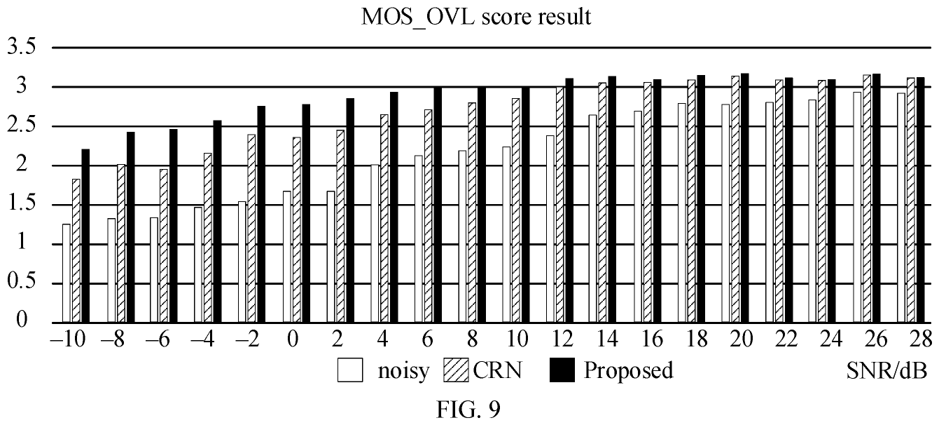

Further, a test result in this embodiment is acquired using 1000 groups of test data with an SNR range of [−10, 30] dB and a stride of 2 dB. Perceptual evaluation of speech quality (PESQ), SI-SNR, and deep noise suppression mean opinion score (DNSMOS) parameters are selected as effect evaluation indicators to determine a test result. Specifically, FIG. 7 shows a test result of a PESQ indicator, FIG. 8 shows a test result of an SI-SNR indicator, and FIG. 9 shows a test result of an MOS_OVL indicator. It can be learned that the target neural network model determined through the foregoing implementation of this application has a capability of learning clean human voice phase information. Compared with the existing technical solution, the present disclosure significantly has a higher effect upper limit, and learning efficiency and output efficiency are higher.

According to the foregoing implementation of this application, the first spectral features of the noisy audio signal are first acquired. The noisy audio signal includes the reference audio signal and the target audio signal to be extracted. The reference audio signal and the target audio signal are each a noise signal or a clean voice signal in the noisy audio signal. The first spectral features are inputted into the target neural network model to obtain reference amplitude estimation information and reference phase estimation information that match the noisy audio signal. The target neural network model is obtained by pre-training according to the sample noisy audio signal and the sample target audio signal. The reference amplitude estimation information is configured for indicating amplitude differences between the target audio signal and the noisy audio signal at a plurality of frequency components, and the reference phase estimation information is configured for indicating phase differences between the target audio signal and the noisy audio signal at the plurality of frequency components. The second spectral features of the target audio signal are determined according to the first spectral features, the reference amplitude estimation information, and the reference phase estimation information. The target audio signal is determined according to the second spectral features, so that estimated values configured for representing phase differences and amplitude differences between audio signals are predicted through the target neural network model. Thus, a processed target audio signal is determined according to predicted reference amplitude estimation information, predicted reference phase estimation information, and spectral features of an original audio signal.

According to the foregoing implementation of this application, a technical solution in which modeling analysis may be performed on both amplitude information and phase information of the noisy audio signal is proposed, so that an audio signal interfered with by noise is obtained through comprehensive processing of the amplitude information and the phase information, thereby improving the accuracy of audio signal processing. Meanwhile, the amplitude information and phase information estimation is acquired through the target neural network, thereby avoiding using the complex neural network model, avoiding increasing the calculation amount, and improving the processing efficiency of audio signal processing.

For simple descriptions, the foregoing method embodiments are stated as a series of combinations of actions. However, a person skilled in the art will appreciate that this application is not limited to the order of actions described, as some steps may be performed in other orders or simultaneously according to this application. In addition, a person skilled in the art will also appreciate that the embodiments described in this specification are all exemplary embodiments, and the involved actions and modules are not necessarily required for this application.

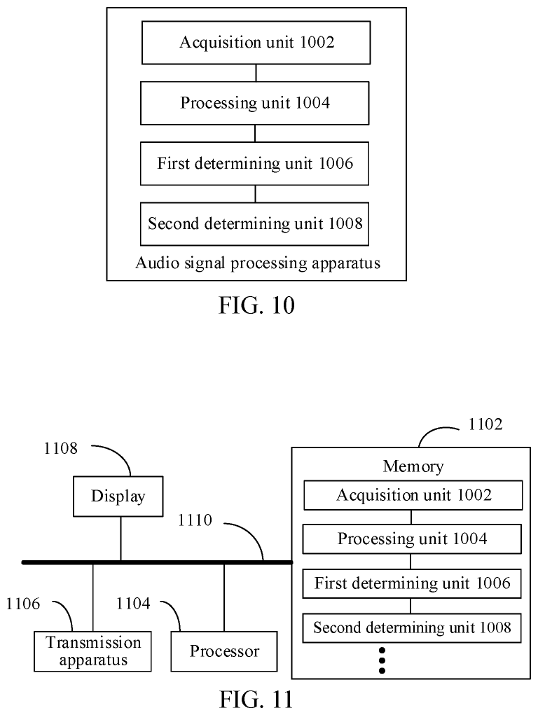

According to another aspect of the embodiments of this application, an audio signal processing apparatus configured to implement the foregoing audio signal processing method is further provided. As shown in FIG. 10, the apparatus includes:
an acquisition unit 1002, configured to acquire first spectral features of a noisy audio signal, the noisy audio signal including a reference audio signal and a target audio signal to be extracted; and the reference audio signal and the target audio signal being each a noise signal or a clean voice signal in the noisy audio signal;
a processing unit 1004, configured to input the first spectral features into a target neural network model to obtain reference phase estimation information matching the noisy audio signal, the target neural network model being obtained by pre-training according to a sample noisy audio signal and a sample target audio signal, and the reference phase estimation information being configured for indicating phase differences between the target audio signal and the noisy audio signal at a plurality of frequency components;
a first determining unit 1006, configured to determine, according to first phase sine values and first phase cosine values that are indicated by the first spectral features, and reference phase sine values and reference phase cosine values that are indicated by the reference phase estimation information, second phase sine values and second phase cosine values that are configured for determining second spectral features; and
a second determining unit 1008, configured to determine the second spectral features according to the second phase sine values and the second phase cosine values, and determine the target audio signal according to the second spectral features.

In some embodiments, the first determining unit 1006 includes: an acquisition module, configured to acquire reference amplitude estimation information outputted by the target neural network model based on the first spectral feature, the reference amplitude estimation information being configured for indicating amplitude differences between the target audio signal and the noisy audio signal at the plurality of frequency components; a first determining module, configured to determine, according to a first audio amplitude indicated by the first spectral features and the reference amplitude estimation information, a second audio amplitude matching the second spectral feature; and a second determining module, configured to determine the second spectral features according to the second audio amplitude, the second phase sine values, and the second phase cosine values.

In some embodiments, a third determining module is configured to: acquire, when the reference amplitude estimation information is configured for indicating reference amplitude ratios of the target audio signal to the noisy audio signal at N frequency components, first amplitude values at the N frequency components indicated by the first spectral features and N reference amplitude ratios indicated by the reference amplitude estimation information, N being an integer greater than 1; and determine product values of N first amplitude values and corresponding reference amplitude ratios as second amplitude values at the N frequency components matching the second spectral features.

In some embodiments, the second determining module is configured to: traverse, when the reference amplitude estimation information is configured for indicating phase differences between the target audio signal and the noisy audio signal at the N frequency components, the N frequency components indicated by the first spectral features, and acquire a first phase sine value and a first phase cosine value that correspond to a currently traversed frequency component, N being an integer greater than 1; acquire, from the reference phase estimation information, a reference phase sine value and a reference phase cosine value that correspond to the currently traversed frequency component; acquire a first product of the first phase sine value and the reference phase cosine value, and a second product of the first phase cosine value and the reference phase sine value, and determine a sum of the first product and the second product as the second phase sine value; and acquire a third product of the first phase cosine value and the reference phase cosine value, and a fourth product of the first phase sine value and the reference phase sine value, and determine the second phase cosine value according to a difference between the third product and the fourth product.

In some embodiments, the third determining module is configured to: determine a real-part representation in the second spectral features according to the second audio amplitude and the second phase cosine values; determine an imaginary-part representation in the second spectral features according to the second audio amplitude and the second phase sine values; and determine the second spectral features according to the real-part representation and the imaginary-part representation.

In some embodiments, the processing unit 1004 includes: a first processing module, configured to encode the first spectral features in the target neural network model through an encoding network to obtain first encoding results; a second processing module, configured to analyze the first encoding results through an RNN constructed based on a GRU, to obtain a first intermediate result carrying temporal information; and a third processing module, configured to input the first encoding results and the first intermediate result into a decoding network in the target neural network model to obtain the reference amplitude estimation information and the reference phase estimation information that match the noisy audio signal, a sub-network in the decoding network being obtained based on adjustment of a sub-network in the encoding network.

In some embodiments, the first processing module is configured to: sequentially encode the first spectral features through M encoding sub-networks that are connected in the encoding network, to obtain M first encoding results, each encoding sub-network including: a convolutional layer, a normalization layer, and an activation layer; when convolving a first spectral feature corresponding to each frame in the convolutional layer, a first spectral feature corresponding to an adjacent previous frame being referenced, and M being a natural number greater than or equal to 2. The second processing module is configured to: during the analysis of the first encoding results through the RNN constructed based on the GRU to obtain the first intermediate result carrying temporal information, input a first encoding result outputted by an M^{th} encoding sub-network into the RNN to obtain the first intermediate result carrying the temporal information. The third processing module is configured to: during the inputting of the first encoding results and the first intermediate result into the decoding network in the target neural network model to obtain the reference amplitude estimation information and the reference phase estimation information that match the noisy audio signal, input the first intermediate result and a first encoding result outputted by an i^{th} encoding sub-network into an (M−i+1)^{th} decoding sub-network, the decoding network including M decoding sub-networks that are connected, each decoding sub-network including: a transposed convolutional layer associated with the convolutional layer, a normalization layer, and an activation layer, i being an integer greater than or equal to 1 and less than or equal to M, and a skip connection being set between the i^{th} encoding sub-network and the (M−i+1)^{th} decoding sub-network; acquire a first decoding result outputted by the M^{th} encoding sub-network; and determine the first decoding result as the reference amplitude estimation information and the reference phase estimation information that match the noisy audio signal.

In some embodiments, the acquisition unit 1002 is configured to: acquire the noisy audio signal; resample the noisy audio signal according to a target sampling rate to obtain a first reference audio signal; perform time-domain framing and windowing on the first reference audio signal according to a framing parameter to obtain a plurality of first audio sub-signals; and perform DFT on the plurality of first audio sub-signals to obtain the first spectral features corresponding to the plurality of first audio sub-signals.

In some embodiments, the acquisition unit 1002 is configured to: acquire a plurality of second spectral features determined according to the first spectral features corresponding to the plurality of first audio sub-signals; perform iSTFT on the plurality of second spectral features to obtain a plurality of second audio sub-signals; and determine the target audio signal according to a concatenation result of the plurality of second audio sub-signals.

In some embodiments, the audio signal processing apparatus is further configured to: determine reference spectral features of the reference audio signal according to the first spectral features and the second spectral features; and perform iSTFT on the reference spectral features to obtain the reference audio signal.

Specific embodiments may refer to the instances shown in the foregoing audio signal processing method. This is not described again in this embodiment.

According to yet another aspect of the embodiments of this application, an electronic device configured to implement the foregoing audio signal processing method is further provided. In this embodiment, an example in which the electronic device is a terminal is used for description. As shown in FIG. 11, the electronic device includes a memory 1102 and a processor 1104. The memory 1102 has a computer program stored therein. The processor 1104 is configured to perform the operations in any one of the foregoing method embodiments through the computer program. In this embodiment, the electronic device may be located in at least one network device of a plurality of network devices in a computer network.

In some embodiments, a person skilled in the art may understand that the structure shown in FIG. 11 is only illustrative. The electronic device may alternatively be a terminal device such as a smartphone (such as an Android mobile phone or an iOS mobile phone), a tablet computer, a palmtop computer, an MID, or a PAD. The structure of the foregoing electronic device is not limited in FIG. 11. For example, the electronic device may further include more or fewer assemblies (for example, a network interface) than those shown in FIG. 11, or has a configuration different from that shown in FIG. 11.

The memory 1102 may be configured to store software programs and modules, for example, program instructions/modules corresponding to the audio signal processing method and apparatus in the embodiments of this application. The processor 1104 runs the software programs and the modules stored in the memory 1102 to execute various functional applications and data processing, that is, implement the foregoing audio signal processing method. The memory 1102 may include a high-speed random access memory (RAM), and may further include a non-volatile memory, for example, one or more magnetic storage apparatuses, a flash memory, or another non-volatile solid-state memory. In some instances, the memory 1102 may further include memories remotely provided relative to the processor 1104, and the remote memories may be connected to a terminal through a network. Instances of the network include, but are not limited to, the Internet, an intranet, a local area network, a mobile communication network, and a combination thereof. The memory 1102 may be specifically, but is not limited to, configured to store information such as the target audio signal. As an example, as shown in FIG. 11, the memory 1102 may include, but is not limited to, the acquisition unit 1002, the processing unit 1004, the first determining unit 1006, and the second determining unit 1008 in the foregoing audio signal processing apparatus. In addition, the memory 1102 may further include, but is not limited to, other module units in the foregoing audio signal processing apparatus. This is not described again in this example.

In some embodiments, a transmission apparatus 1106 is configured to receive or transmit data through a network. Specific instances of the foregoing network may include a wired network and a wireless network. In an instance, the transmission apparatus 1106 includes a network interface controller (NIC). The NIC may be connected to another network device and a router through a network cable, so as to communicate with the Internet or a local area network. In an instance, the transmission apparatus 1106 is a radio frequency (RF) module, which is configured to communicate with the Internet in a wireless manner.

In addition, the foregoing electronic device further includes a display 1108, and a connection bus 1110 configured to connect various module components in the electronic device.

In other embodiments, the terminal device or the server may be a node in a distributed system. The distributed system may be a blockchain system, and the blockchain system may be a distributed system formed by connecting a plurality of nodes through network communication. A peer-to-peer network may be formed between the nodes. A computing device in any form, for example, an electronic device such as a server or a terminal, may become a node in the blockchain system by joining the peer-to-peer network.

According to an aspect of this application, a computer program product is provided, including a computer program/instruction. The computer program/instruction contains program code configured for performing the foregoing method. In such an embodiment, the computer program may be downloaded and installed from the network through a communication part, and/or may be installed from a removable medium. When the computer program is executed by a central processing unit, the computer program executes various functions provided in the embodiments of this application.

According to an aspect of this application, a computer-readable storage medium is provided. A processor of an electronic device reads the computer instruction from the computer-readable storage medium and executes the computer instruction to cause the electronic device to perform the foregoing audio signal processing method.

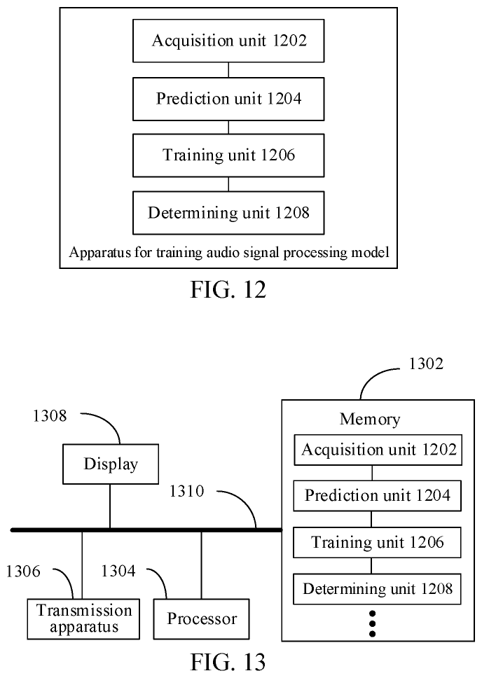

According to another aspect of the embodiments of this application, an apparatus for training an audio signal processing model configured to implement the foregoing method for training an audio signal processing model is further provided. As shown in FIG. 12, the apparatus includes:
an acquisition unit 1202, configured to acquire first spectral features of a sample noisy audio signal and a training label matching the sample noisy audio signal, the sample noisy audio signal including a sample reference audio signal and a sample target audio signal; the training label including a phase difference label, and the phase difference label being determined according to first sample vector cosine values and first sample vector sine values that are indicated by the first spectral features of the sample noisy audio signal, and second sample vector cosine values and second sample vector sine values that are indicated by second spectral features of the sample target audio signal; and the sample reference audio signal and the sample target audio signal being each a sample noise signal or a sample clean voice signal in the sample noisy audio signal;
a prediction unit 1204, configured to input the first spectral features into a to-be-trained audio signal processing model to obtain reference phase estimation information matching the sample noisy audio signal;
a training unit 1206, configured to train the audio signal processing model according to the reference phase estimation information and a training loss determined by the training label; and
a determining unit 1208, configured to determine, when the training loss satisfies a target convergence condition, a trained audio signal processing model as a target neural network model.

In some embodiments, the training unit 1206 is configured to: input the first spectral features into the to-be-trained audio signal processing model to obtain reference amplitude estimation information matching the sample noisy audio signal, an amplitude difference label being determined according to amplitude differences between the sample noisy audio signal and the sample target audio signal at a plurality of frequency components; and train the audio signal processing model according to the reference amplitude estimation information, the reference phase estimation information, and the training loss determined by the training label.

In some embodiments, the acquisition unit 1202 includes: a first acquisition module, configured to acquire the sample target audio signal and the sample reference audio signal, and obtain the sample noisy audio signal by mixing the sample target audio signal and the sample reference audio signal; a second acquisition module, configured to separately acquire the first spectral features of the sample noisy audio signal and the second spectral features of the sample target audio signal; and a third acquisition module, configured to determine the amplitude difference label and the phase difference label according to the first spectral features and the second spectral features.

In some embodiments, the third acquisition module is configured to: acquire first sample amplitude values of the sample noisy audio signal at N frequency components according to the first spectral features, and acquire second sample amplitude values of the sample target audio signal at the N frequency components according to the second spectral features, N being an integer greater than 1; determine the amplitude difference label according to ratios of N second sample amplitude values to corresponding first sample amplitude values; acquire first sample vector cosine values and first sample vector sine values of the sample noisy audio signal at the N frequency components according to the first spectral features, and acquire second sample vector cosine values and second sample vector sine values of the sample target audio signal at the N frequency components according to the second spectral features; and determine the phase difference label according to N first sample vector cosine values, N sample vector sine values, corresponding second sample vector cosine values, and corresponding second sample vector sine values.

In some embodiments, the prediction unit 1204 is configured to: encode the first spectral features in the audio signal processing model through an encoding network to obtain first encoding results; analyze the first encoding results through an RNN constructed based on a GRU, to obtain a first intermediate result carrying temporal information; and input the first encoding results and the first intermediate result into a decoding network in the audio signal processing model to obtain the reference amplitude estimation information and the reference phase estimation information that match the sample noisy audio signal, a sub-network in the decoding network being obtained based on adjustment of a sub-network in the encoding network.

Specific embodiments may refer to the instances shown in the foregoing method for training an audio signal processing model. This is not described again in this embodiment.

According to yet another aspect of the embodiments of this application, an electronic device configured to implement the foregoing method for training an audio signal processing model is further provided. In this embodiment, an example in which the electronic device is a terminal is used for description. As shown in FIG. 13, the electronic device includes a memory 1302 and a processor 1304. The memory 1302 has a computer program stored therein. The processor 1304 is configured to perform the operations in any one of the foregoing method embodiments through the computer program.

In this embodiment, the electronic device may be located in at least one network device of a plurality of network devices in a computer network.

In some embodiments, a person skilled in the art may understand that the structure shown in FIG. 13 is only illustrative. The electronic device may alternatively be a terminal device such as a smartphone (such as an Android mobile phone or an iOS mobile phone), a tablet computer, a palmtop computer, an MID, or a PAD. The structure of the foregoing electronic device is not limited in FIG. 13. For example, the electronic device may further include more or fewer assemblies (for example, a network interface) than those shown in FIG. 13, or has a configuration different from that shown in FIG. 13.

The memory 1302 may be configured to store software programs and modules, for example, program instructions/modules corresponding to the method and apparatus for training an audio signal processing model in the embodiments of this application. The processor 1304 runs the software programs and the modules stored in the memory 1302 to execute various functional applications and data processing, that is, implement the foregoing method for training an audio signal processing model. The memory 1302 may include a high-speed RAM, and may further include a non-volatile memory, for example, one or more magnetic storage apparatuses, a flash memory, or another non-volatile solid-state memory. In some instances, the memory 1302 may further include memories remotely provided relative to the processor 1304, and the remote memories may be connected to a terminal through a network. Instances of the network include, but are not limited to, the Internet, an intranet, a local area network, a mobile communication network, and a combination thereof. The memory 1302 may be specifically, but is not limited to, configured to store information such as the target audio signal. As an example, as shown in FIG. 13, the memory 1302 may include, but is not limited to, the acquisition unit 1202, the prediction unit 1204, the training unit 1206, and the determining unit 1208 in the foregoing apparatus for training an audio signal processing model. In addition, the memory 1302 may further include, but is not limited to, other module units in the foregoing apparatus for training an audio signal processing model. This is not described again in this example.

In some embodiments, a transmission apparatus 1306 is configured to receive or transmit data through a network. Specific instances of the foregoing network may include a wired network and a wireless network. In an instance, the transmission apparatus 1306 includes an NIC. The NIC may be connected to another network device and a router through a network cable, so as to communicate with the Internet or a local area network. In an instance, the transmission apparatus 1306 is an RF module, which is configured to communicate with the Internet in a wireless manner.

In addition, the foregoing electronic device further includes a display 1308, and a connection bus 1310 configured to connect various module components in the electronic device.

In other embodiments, the terminal device or the server may be a node in a distributed system. The distributed system may be a blockchain system, and the blockchain system may be a distributed system formed by connecting a plurality of nodes through network communication. A peer-to-peer network may be formed between the nodes. A computing device in any form, for example, an electronic device such as a server or a terminal, may become a node in the blockchain system by joining the peer-to-peer network.

According to an aspect of this application, a computer program product is provided, including a computer program/instruction. The computer program/instruction contains program code configured for performing the foregoing method. In such an embodiment, the computer program may be downloaded and installed from the network through a communication part, and/or may be installed from a removable medium. When the computer program is executed by a central processing unit, the computer program executes various functions provided in the embodiments of this application.

According to an aspect of this application, a computer-readable storage medium is provided. A processor of an electronic device reads the computer instruction from the computer-readable storage medium and executes the computer instruction to cause the electronic device to perform the foregoing method for training an audio signal processing model.

In this embodiment, a person skilled in the art may understand that all or some of the operations in various methods in the foregoing embodiments may be completed by a program instructing relevant hardware of a terminal device. The program may be stored in a computer-readable storage medium. The storage medium may include: a flash disk, a read-only memory (ROM), a RAM, a magnetic disk, an optical disc, or the like.

When the integrated unit in the foregoing embodiments is implemented in a form of a software functional unit and sold or used as an independent product, the integrated unit may be stored in the foregoing computer-readable storage medium. Based on such an understanding, the technical solutions of this application essentially, or a part contributing to the related art, or all or a part of the technical solution may be embodied in a form of a software product. The computer software product is stored in a storage medium and includes several instructions for causing one or more electronic devices (which may be a personal computer, a server, a network device, or the like) to perform all or a part of the operations of the methods in the embodiments of this application.

In the embodiments of this application, the term “module” or “unit” refers to a computer program having a predetermined function or a part of a computer program, operates together with other relevant parts to achieve a predetermined objective, and may be all or partially implemented through software, hardware (such as a processing circuit or a memory), or a combination thereof. Similarly, one processor (or a plurality of processors or memories) may be configured to implement one or more modules or units. In addition, each module or unit may be a part of an overall module or unit including a function of the module or unit.

In the foregoing embodiments of this application, the descriptions of the embodiments have respective focuses. A part that is not described in detail in an embodiment may refer to related descriptions of other embodiments.

In the several embodiments provided in this application, the disclosed client may be implemented in other manners. The foregoing apparatus embodiments are merely illustrative. For example, the unit division is merely a logical function division and may be other division during actual implementation. For example, a plurality of units or assemblies may be combined or integrated into another system, or some features may be ignored or not executed. In addition, the displayed or discussed coupling, direct coupling, or communication connection may be the indirect coupling or communication connection through some interfaces, units, or modules, and may be electrical or of other forms.

The units illustrated as separate components may or may not be physically separated, and the components shown as units may or may not be physical units, that is, may be located in one place, or may be distributed over a plurality of network units. Some or all of the units may be selected to achieve the object of the solutions of the embodiments according to actual needs.

In addition, the functional units in various embodiments of this application may be integrated in one processing unit, or each unit may physically exist separately, or two or more units may be integrated in one single unit. The integrated unit may be implemented in the form of hardware, or may be implemented in the form of a software functional unit.

Technical features of the foregoing embodiments may be combined in different manners to form other embodiments. To make description concise, not all possible combinations of the technical features in the foregoing embodiments are described. However, as long as no conflict exists, the combinations of these technical features shall be considered as falling within the scope recorded by this specification.

The foregoing embodiments express only several implementations of this application, which are described in a relatively specific and detailed manner, but are not to be construed as a limitation of the patent scope. For a person skilled in the art, several transformations and improvements may be made without departing from the idea of this application. These transformations and improvements belong to the protection scope of this application. Therefore, the protection scope of the patent of this application shall be subject to the appended claims.

What is claimed is:

1. An audio signal processing method performed by an electronic device, the method comprising:
acquiring first spectral features of a noisy audio signal, the noisy audio signal comprising a reference audio signal and a target audio signal to be extracted;
inputting the first spectral features into a target neural network model to obtain reference phase estimation information matching the noisy audio signal, and the reference phase estimation information being configured for indicating phase differences between the target audio signal and the noisy audio signal at a plurality of frequency components;
determining second spectral features according to the first spectral features and the reference phase estimation information; and
determining the target audio signal according to the second spectral features.

2. The method according to claim 1, wherein the determining second spectral features according to the first spectral features and the reference phase estimation information comprises:
determining, according to first phase sine values and first phase cosine values of the first spectral features, and reference phase sine values and reference phase cosine values of the reference phase estimation information, second phase sine values and second phase cosine values that are configured for determining the second spectral features;
acquiring reference amplitude estimation information outputted by the target neural network model based on the first spectral features, the reference amplitude estimation information being configured for indicating amplitude differences between the target audio signal and the noisy audio signal at the plurality of frequency components;
determining, according to a first audio amplitude indicated by the first spectral features and the reference amplitude estimation information, a second audio amplitude configured for determining the second spectral features; and
determining the second spectral features according to the second audio amplitude, the second phase sine values, and the second phase cosine values.

3. The method according to claim 2, wherein the determining, according to a first audio amplitude indicated by the first spectral features and the reference amplitude estimation information, a second audio amplitude configured for determining the second spectral features comprises:
acquiring, when the reference amplitude estimation information is configured for indicating reference amplitude ratios of the target audio signal to the noisy audio signal at N frequency components, first amplitude values at the N frequency components indicated by the first spectral features and N reference amplitude ratios indicated by the reference amplitude estimation information, N being an integer greater than 1; and
determining product values of N first amplitude values and corresponding reference amplitude ratios as second amplitude values at the N frequency components matching the second spectral features.

4. The method according to claim 2, wherein the determining, according to first phase sine values and first phase cosine values that are indicated by the first spectral features, and reference phase sine values and reference phase cosine values that are indicated by the reference phase estimation information, second phase sine values and second phase cosine values that are configured for determining second spectral features comprises:
traversing, when the reference amplitude estimation information is configured for indicating phase differences between the target audio signal and the noisy audio signal at the N frequency components, the N frequency components indicated by the first spectral features, and acquiring a first phase sine value and a first phase cosine value that correspond to a currently traversed frequency component, N being an integer greater than 1;
acquiring, from the reference phase estimation information, a reference phase sine value and a reference phase cosine value that correspond to the currently traversed frequency component;
acquiring a first product of the first phase sine value and the reference phase cosine value, and a second product of the first phase cosine value and the reference phase sine value, and determining a sum of the first product and the second product as the second phase sine value; and
acquiring a third product of the first phase cosine value and the reference phase cosine value, and a fourth product of the first phase sine value and the reference phase sine value, and determining the second phase cosine value according to a difference between the third product and the fourth product.

5. The method according to claim 2, wherein the determining the second spectral features according to the second audio amplitude, the second phase sine values, and the second phase cosine values comprises:
determining a real-part representation in the second spectral features according to the second audio amplitude and the second phase cosine values;
determining an imaginary-part representation in the second spectral features according to the second audio amplitude and the second phase sine values; and
determining the second spectral features according to the real-part representation and the imaginary-part representation.

6. The method according to claim 1, wherein the inputting the first spectral features into a target neural network model to obtain reference phase estimation information matching the noisy audio signal comprises:
encoding the first spectral features in the target neural network model through an encoding network to obtain first encoding results;
analyzing the first encoding results through a recurrent neural network (RNN) constructed based on a gated recurrent unit (GRU), to obtain a first intermediate result carrying temporal information; and
inputting the first encoding results and the first intermediate result into a decoding network in the target neural network model to obtain the reference amplitude estimation information and the reference phase estimation information that match the noisy audio signal, a sub-network in the decoding network being obtained based on adjustment of a sub-network in the encoding network.

7. The method according to claim 1, wherein after the determining the second spectral features, the method further comprises:
determining reference spectral features of the reference audio signal according to the first spectral features and the second spectral features; and
performing iSTFT on the reference spectral features to obtain the reference audio signal.

8. The method according to claim 1, wherein the target neural network model is trained by:
acquiring first spectral features of a sample noisy audio signal and a training label matching the sample noisy audio signal, the sample noisy audio signal comprising a sample reference audio signal and a sample target audio signal; the training label comprising a phase difference label, and the phase difference label being determined according to first sample vector cosine values and first sample vector sine values that are indicated by the first spectral features of the sample noisy audio signal, and second sample vector cosine values and second sample vector sine values that are indicated by second spectral features of the sample target audio signal; and the sample reference audio signal and the sample target audio signal being each a sample noise signal or a sample clean voice signal in the sample noisy audio signal;
inputting the first spectral features into a to-be-trained audio signal processing model to obtain reference phase estimation information matching the sample noisy audio signal;
training the audio signal processing model according to the reference phase estimation information and a training loss determined by the training label; and
determining, when the training loss satisfies a target convergence condition, a trained audio signal processing model as a target neural network model.

9. An electronic device, comprising a memory and a processor, the memory having a computer program stored therein, and the computer program, when executed by the processor, causing the electronic device to perform an audio signal processing method including:
acquiring first spectral features of a noisy audio signal, the noisy audio signal comprising a reference audio signal and a target audio signal to be extracted;
inputting the first spectral features into a target neural network model to obtain reference phase estimation information matching the noisy audio signal, and the reference phase estimation information being configured for indicating phase differences between the target audio signal and the noisy audio signal at a plurality of frequency components;
determining second spectral features according to the first spectral features and the reference phase estimation information; and
determining the target audio signal according to the second spectral features.

10. The electronic device according to claim 9, wherein the determining second spectral features according to the first spectral features and the reference phase estimation information comprises:
determining, according to first phase sine values and first phase cosine values of the first spectral features, and reference phase sine values and reference phase cosine values of the reference phase estimation information, second phase sine values and second phase cosine values that are configured for determining the second spectral features;
acquiring reference amplitude estimation information outputted by the target neural network model based on the first spectral features, the reference amplitude estimation information being configured for indicating amplitude differences between the target audio signal and the noisy audio signal at the plurality of frequency components;
determining, according to a first audio amplitude indicated by the first spectral features and the reference amplitude estimation information, a second audio amplitude configured for determining the second spectral features; and
determining the second spectral features according to the second audio amplitude, the second phase sine values, and the second phase cosine values.

11. The electronic device according to claim 10, wherein the determining, according to a first audio amplitude indicated by the first spectral features and the reference amplitude estimation information, a second audio amplitude configured for determining the second spectral features comprises:
acquiring, when the reference amplitude estimation information is configured for indicating reference amplitude ratios of the target audio signal to the noisy audio signal at N frequency components, first amplitude values at the N frequency components indicated by the first spectral features and N reference amplitude ratios indicated by the reference amplitude estimation information, N being an integer greater than 1; and
determining product values of N first amplitude values and corresponding reference amplitude ratios as second amplitude values at the N frequency components matching the second spectral features.

12. The electronic device according to claim 10, wherein the determining, according to first phase sine values and first phase cosine values that are indicated by the first spectral features, and reference phase sine values and reference phase cosine values that are indicated by the reference phase estimation information, second phase sine values and second phase cosine values that are configured for determining second spectral features comprises:
traversing, when the reference amplitude estimation information is configured for indicating phase differences between the target audio signal and the noisy audio signal at the N frequency components, the N frequency components indicated by the first spectral features, and acquiring a first phase sine value and a first phase cosine value that correspond to a currently traversed frequency component, N being an integer greater than 1;
acquiring, from the reference phase estimation information, a reference phase sine value and a reference phase cosine value that correspond to the currently traversed frequency component;
acquiring a first product of the first phase sine value and the reference phase cosine value, and a second product of the first phase cosine value and the reference phase sine value, and determining a sum of the first product and the second product as the second phase sine value; and
acquiring a third product of the first phase cosine value and the reference phase cosine value, and a fourth product of the first phase sine value and the reference phase sine value, and determining the second phase cosine value according to a difference between the third product and the fourth product.

13. The electronic device according to claim 10, wherein the determining the second spectral features according to the second audio amplitude, the second phase sine values, and the second phase cosine values comprises:
determining a real-part representation in the second spectral features according to the second audio amplitude and the second phase cosine values;
determining an imaginary-part representation in the second spectral features according to the second audio amplitude and the second phase sine values; and
determining the second spectral features according to the real-part representation and the imaginary-part representation.

14. The electronic device according to claim 9, wherein the inputting the first spectral features into a target neural network model to obtain reference phase estimation information matching the noisy audio signal comprises:
encoding the first spectral features in the target neural network model through an encoding network to obtain first encoding results;
analyzing the first encoding results through a recurrent neural network (RNN) constructed based on a gated recurrent unit (GRU), to obtain a first intermediate result carrying temporal information; and
inputting the first encoding results and the first intermediate result into a decoding network in the target neural network model to obtain the reference amplitude estimation information and the reference phase estimation information that match the noisy audio signal, a sub-network in the decoding network being obtained based on adjustment of a sub-network in the encoding network.

15. The electronic device according to claim 9, wherein after the determining the second spectral features, the method further comprises:
determining reference spectral features of the reference audio signal according to the first spectral features and the second spectral features; and
performing iSTFT on the reference spectral features to obtain the reference audio signal.

16. The electronic device according to claim 9, wherein the target neural network model is trained by:
acquiring first spectral features of a sample noisy audio signal and a training label matching the sample noisy audio signal, the sample noisy audio signal comprising a sample reference audio signal and a sample target audio signal; the training label comprising a phase difference label, and the phase difference label being determined according to first sample vector cosine values and first sample vector sine values that are indicated by the first spectral features of the sample noisy audio signal, and second sample vector cosine values and second sample vector sine values that are indicated by second spectral features of the sample target audio signal; and the sample reference audio signal and the sample target audio signal being each a sample noise signal or a sample clean voice signal in the sample noisy audio signal;
inputting the first spectral features into a to-be-trained audio signal processing model to obtain reference phase estimation information matching the sample noisy audio signal;
training the audio signal processing model according to the reference phase estimation information and a training loss determined by the training label; and
determining, when the training loss satisfies a target convergence condition, a trained audio signal processing model as a target neural network model.

17. A non-transitory computer-readable storage medium, having a program stored therein, the program, when executed by a processor of an electronic device, causing the electronic device to perform an audio signal processing method including:
acquiring first spectral features of a noisy audio signal, the noisy audio signal comprising a reference audio signal and a target audio signal to be extracted;
inputting the first spectral features into a target neural network model to obtain reference phase estimation information matching the noisy audio signal, and the reference phase estimation information being configured for indicating phase differences between the target audio signal and the noisy audio signal at a plurality of frequency components;
determining second spectral features according to the first spectral features and the reference phase estimation information; and
determining the target audio signal according to the second spectral features.

18. The non-transitory computer-readable storage medium according to claim 17, wherein the determining second spectral features according to the first spectral features and the reference phase estimation information comprises:
determining, according to first phase sine values and first phase cosine values of the first spectral features, and reference phase sine values and reference phase cosine values of the reference phase estimation information, second phase sine values and second phase cosine values that are configured for determining the second spectral features;
acquiring reference amplitude estimation information outputted by the target neural network model based on the first spectral features, the reference amplitude estimation information being configured for indicating amplitude differences between the target audio signal and the noisy audio signal at the plurality of frequency components;
determining, according to a first audio amplitude indicated by the first spectral features and the reference amplitude estimation information, a second audio amplitude configured for determining the second spectral features; and
determining the second spectral features according to the second audio amplitude, the second phase sine values, and the second phase cosine values.

19. The non-transitory computer-readable storage medium according to claim 17, wherein the inputting the first spectral features into a target neural network model to obtain reference phase estimation information matching the noisy audio signal comprises:
encoding the first spectral features in the target neural network model through an encoding network to obtain first encoding results;
analyzing the first encoding results through a recurrent neural network (RNN) constructed based on a gated recurrent unit (GRU), to obtain a first intermediate result carrying temporal information; and
inputting the first encoding results and the first intermediate result into a decoding network in the target neural network model to obtain the reference amplitude estimation information and the reference phase estimation information that match the noisy audio signal, a sub-network in the decoding network being obtained based on adjustment of a sub-network in the encoding network.

20. The non-transitory computer-readable storage medium according to claim 17, wherein after the determining the second spectral features, the method further comprises:
determining reference spectral features of the reference audio signal according to the first spectral features and the second spectral features; and
performing iSTFT on the reference spectral features to obtain the reference audio signal.
